(19) United States
(12) Patent Application Publication
(10) Pub. No.: US 2020/0348846 A1
(43) Pub. Date: Nov. 5, 2020

(54) METHOD AND SYSTEM FOR INTELLIGENT ENVIRONMENT AWARE SOFTWARE DEFINED ENTERPRISE MULTI-APPLICATION PROTECTION

(71) Applicant: EMC IP Holding Company LLC, Hopkinton, MA (US)

(72) Inventors: Shelesh Chopra, Bangalore (IN); Sunil K. Yadav, Bangalore (IN); Aaditya Rakesh Bansal, Bangalore (IN); Jayashree B. Radha, Bangalore (IN); Amit Jain, Bangalore (IN); Manish Sharma, Bangalore (IN)

(21) Appl. No.: 16/401,665

(22) Filed: May 2, 2019

(51) Int. Cl. G06F 3/06; G06F 8/61

(52) U.S. Cl. CPC G06F 3/065; G06F 8/61; G06F 3/0673; G06F 3/0619

(57) ABSTRACT

In general, in one aspect, the invention relates to a method for managing backups. The method includes, in response detecting that a new application has been installed on a production host, issuing a notification to a management device, receiving, in response to the notification, an application specific installation package, installing the application specific installation package on the production host to obtain an installed agent on the production host, associating a backup policy with the agent, and where at least a portion of data associated with the application is backed up in accordance with the backup policy using the agent.

### BACKGROUND

Computing devices may generate data during their operation. For example, applications hosted by the computing devices may generate data. Such data may be backed up and subsequently stored in persistent storage of backup storage device(s).

### SUMMARY

In general, in one aspect, the invention relates to a method for managing backups, the method comprising in response detecting that a new application has been installed on a production host, issuing a notification to a management device, receiving, in response to the notification, an application specific installation package, installing the application specific installation package on the production host to obtain an installed agent on the production host, associating a backup policy with the agent, and wherein at least a portion of data associated with the application is backed up in accordance with the backup policy using the agent.

In general, in one aspect, the invention relates to a non-transitory computer readable medium comprising computer readable program code, which when executed by a computer processor enables the computer processor to perform a method for managing backups, the method comprising in response detecting that a new application has been installed on a production host, issuing a notification to a management device, receiving, in response to the notification, an application specific installation package, installing the application specific installation package on the production host to obtain an installed agent on the production host, associating a backup policy with the agent, and wherein at least a portion of data associated with the application is backed up in accordance with the backup policy using the agent.

In general, in one aspect, the invention relates to a system, the system comprising a processor, memory comprising instructions, which when executed by the processor, perform a method, the method comprising in response detecting that a new application has been installed on a production host, issuing a notification to a management device, receiving, in response to the notification, an application specific installation package, installing the application specific installation package on the production host to obtain an installed agent on the production host, associating a backup policy with the agent, and wherein at least a portion of data associated with the application is backed up in accordance with the backup policy using the agent.

Other aspects of the invention will be apparent from the following description and the appended claims.

### BRIEF DESCRIPTION OF DRAWINGS

FIG. 1 shows a system in accordance with one or more embodiments of the invention.

FIG. 2 shows a method for managing backup operations in accordance with one or more embodiments of the invention.

FIG. 3A shows a method for detecting installation of a new application on a production host in accordance with one or more embodiments of the invention.

FIG. 3B shows a method for installing an application specific installation package on a production host in accordance with one or more embodiments of the invention.

FIG. 4 shows a method for associating a backup policy with a heterogeneous set of assets on a production host in accordance with one or more embodiments of the invention.

FIG. 5 shows an exemplary system in accordance with one or more embodiments of the invention.

FIG. 6 shows a computing system in accordance with one or more embodiments of the invention.

### DETAILED DESCRIPTION

Specific embodiments will now be described with reference to the accompanying figures. In the following description, numerous details are set forth as examples of the invention. It will be understood by those skilled in the art, and having the benefit of this Detailed Description, that one or more embodiments of the present invention may be practiced without these specific details and that numerous variations or modifications may be possible without departing from the scope of the invention. Certain details known to those of ordinary skill in the art may be omitted to avoid obscuring the description.

Further, in the following description of the figures, any component described with regard to a figure, in various embodiments of the invention, may be equivalent to one or more like-named components shown and/or described with regard to any other figure. For brevity, descriptions of these components may not be repeated with regard to each figure. Thus, each and every embodiment of the components of each figure, or that is otherwise described herein, is incorporated by reference and assumed to be optionally present within every other figure and/or embodiment having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure and/or embodiment.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the invention relate to managing backup operations on production hosts. One or more embodiments of the invention enable multiple agents to be concurrently executed on a production host, where each of the agents includes functionality to specifically backup data associated with a given application(s). More specifically, embodiments of the invention relate to: (i) automatically discovering applications installed on a production host; (ii) determining which application specific agent (e.g., application specific backup agent) to install on the production host to protect the application; (iii) determining what Protection Life Cycles (PLCs) (also referred to as backup policies) to apply to the application; and (iv) installing only unique components and using (and not installing) common components required by the installed application specific agent is such common components are already installed. Once the agent is installed, the agent may be automatically associated with one or more backup policies. In this manner, embodiments of the invention provide an automated framework that enables agent-driven end-to-end data protection on production hosts.

Further, embodiments of the invention relate to the installation of plugins on the backup agent executing on the production host to determine, at a more granular level, what assets are stored on each virtual machine. The assets (which are typically heterogeneous in nature) may then be classified to determine common features. The common features may then be used to group the assets into backup groups, where each of the backup groups (or assets within the backup groups) may be associated with a backup policy, where the backup policy may be selected from a finite set of backup policies. This approach allows for more efficient backup of heterogeneous assets using a finite set of backup policies.

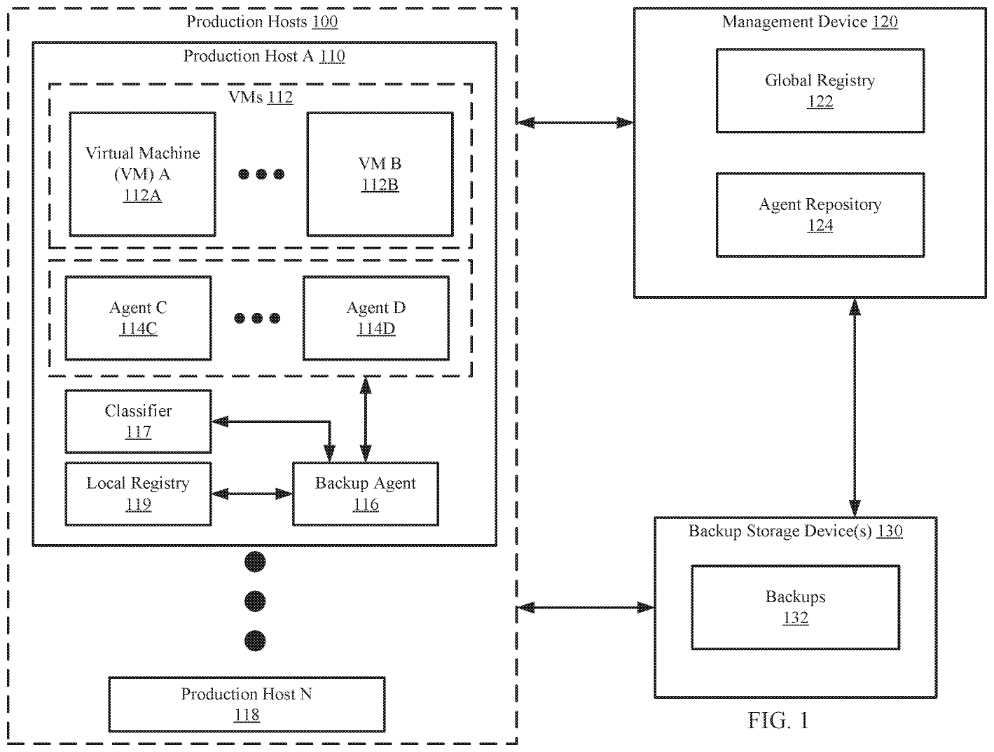

FIG. 1 shows a diagram of a system in accordance with one or more embodiments of the invention. The system includes clients (not shown), one or more production hosts (100), a management device (120), and one or more backup storage device(s) (130). The system may include additional, fewer, and/or different components without departing from the invention. Each component may be operably connected via any combination of wired and/or wireless connections. Each component illustrated in FIG. 1 is discussed below.

In one or more embodiments of the invention, the clients (not shown) are devices, operated by users, that utilize data generated by the production hosts (100). The clients may send requests to the production hosts (100) to obtain the data to be utilized.

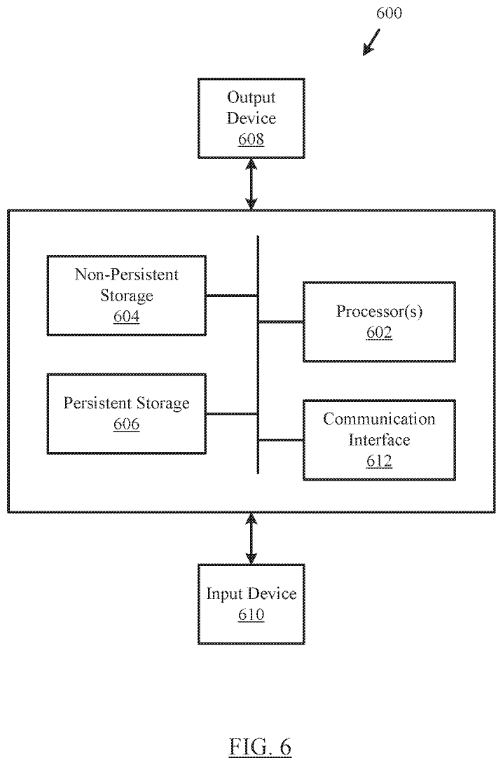

In one or more embodiments of the invention, one or more clients are implemented as computing devices (see e.g., FIG. 6). A computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of a client described throughout this application.

In one or more embodiments of the invention, one or more clients are implemented as logical devices. The logical device may utilize the computing resources of any number of computing devices and thereby provide the functionality of the clients described throughout this application.

In one or more embodiments of the invention, the management device (120) is a device (physical or logical) that interacts with the backup storage device(s) and the production hosts to manage the generation of backups (132).

In one or more embodiments of the invention, the management device includes a global registry (122) and an agent repository (124). The global registry may be a data-structure(s) that specifies, which application specific agents (also referred to as agents (e.g., 114C, 114D)) are executing on each of the production hosts. The global registry (122) may also specify the backup policies associated with each of the agents.

The agent repository (124) may include the corresponding computer executable code for the various application specific agents (e.g., Agent C (114C), Agent D (114D)). In one embodiment of the invention, each agent is a combination of one or more unique components and zero, one, or more common components. Each agent is associated with a specific application(s) and, as such, includes functionality to interact with the specific application(s) in order to generate a backup of the application data (e.g., any data associated with the application) or a portion thereof. The unique component(s) of the agent provide the specific functionality to enable the agent to interact with the specific application(s) in order to generate a backup of the application data. For example, the unique components may be configured to interact with the specific application(s) using application programming interfaces (APIs) associated with the specific application(s).

If agent includes common components, then the unique components may act as an interface between the specific application(s) and the common components in order to utilize the functionality of the common components to generate backups for the application data. Examples of common components include, but are not limited to, a logging component, a snapshot component (e.g., to generate snapshots of the application data), a discovery component (e.g., to determine presence of common infrastructure), a licensing component (e.g., to track licenses associated with an application, a capacity calculation component (e.g., to determine the capacity of the production host, virtual machine, etc.), and a common data transport component (e.g., to provide data transport/communication functionality to the agent). Additionally, or alternatively, the unique components may include functionality to orchestrate the usage of the various common components in order to generate a backup of the application data. Each of the common components is application agnostic or at least may be included within multiple different agents, where each agent is associated with a different application or set of applications.

The following is a non-limiting example to illustrate the use of common components and unique components in different agents. Consider a scenario in which Agent A is configured to backup Application A and Agent B is configured to backup Application B. Agent A includes a unique component (component X) and two common components (component 1, component 2). In this example, component 1 is a logging component and component 2 is a snapshot component. Component X is configured to interface with Application A using one or more application programming interfaces (APIs) exposed by Application A. In addition, component X includes functionality to use the features of components 1 and 2, namely the logging feature and the snapshot feature, in order to generate a backup of application data associated with Application A.

Agent B includes a unique component (component Y) and two common components (component 1, component 2). Component Y is configured to interface with Application B using one or more APIs exposed by Application B. In addition, component Y includes functionality to use the features of components 1 and 2, in order to generate a backup of application data associated with Application B. As discussed above, the different agents (i.e., Agents A and B in this example), can interface with different applications that utilize different APIs but still leverage common components in order to generate the backups.

Continuing with the discussion of FIG. 1, in one or more embodiments of the invention, the management device (120) is implemented as a computing device (see e.g., FIG. 6). The computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the management device described throughout this application.

In one or more embodiments of the invention, the management device (120) is implemented as a logical device. The logical device may utilize the computing resources of any number of computing devices and thereby provide the functionality of the management device (120) described throughout this application.

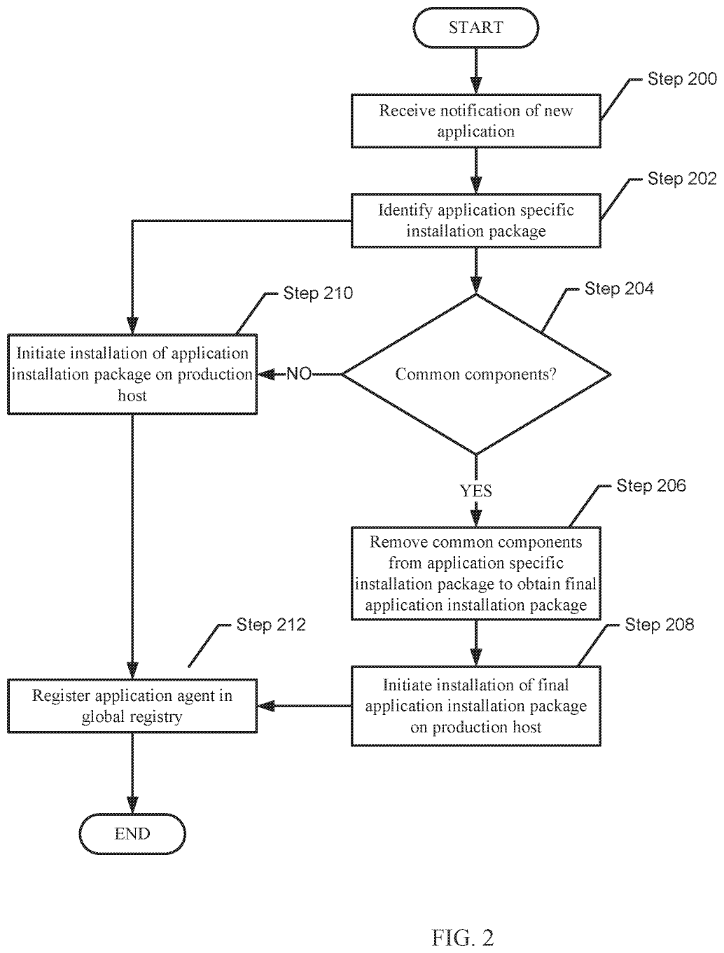

Additional detail about the operation of the management device is provided below with respect to FIGS. 2-4.

In one or more embodiments of the invention, the production hosts (100) host any number of virtual machines (VMs) (112A, 112B). In one or more of embodiments of the invention, the virtual machines (112A, 112B) are implemented as computer instructions, e.g., computer code, stored on a persistent storage (e.g., on the production host (110, 118)) that when executed by a processor(s) of the production host (110, 118) cause the production host (110, 118) to provide the functionality of the virtual machines (112A, 112B) described throughout this application.

In one or more embodiments of the invention, the production host (110, 118) is implemented as a computing device (see e.g., FIG. 6). The computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the production host (110, 118) described throughout this application.

In one or more embodiments of the invention, the production host (110, 118) is implemented as a logical device. The logical device may utilize the computing resources of any number of computing devices and thereby provide the functionality of the production host (110, 118) described throughout this application.

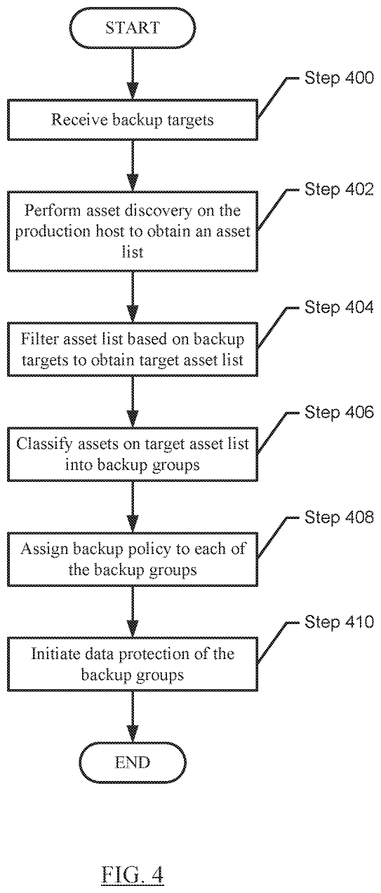

In one embodiment of the invention, the production hosts may include application specific agents (also referred to as Agents) (e.g., 114C, 114D) and backup agents (e.g., 116). The application specific agents may interact directly with specific applications (not shown) executing on the VMs in order to generate backups of all or a portion of the data associated with the aforementioned applications. The manner in which the application specific agents generate the backups may be based on the associated backup policy. One or more backup policies may be assigned to a given application and implemented using the corresponding application specific agent. The assignment of the backup policy(ies) may initially be performed by the backup agent (116) and then updated and/or modified by the classifier (117) (see e.g., FIG. 4).

In one embodiment of the invention, the backup agent (116) includes functionality to coordinate the interaction between the management device and the application specific agents. More specifically, the backup agent (116) includes functionality to communicate with the agents on the production host as well as communicate with the management device (120). The backup agent may also include functionality to query and/or populate the local registry (119) (described below) as part of installing one or more agents (see e.g., FIG. 2 below). In addition, the backup agent (116) may also include functionality to perform all or a portion of the method shown in FIG. 4. Additional detail about the operation of the backup agent is described with respect to FIGS. 2-4 below.

By logically interposing the backup agent (116) between the management device and the application specific agents, the management device does not need to directly interact with all of the application specific agents. This may enable multiple agents to be concurrently executing on the production agents, where the agents are locally managed by the backup agent. The backup agent may, as needed, communicate with management device as part of its management functionality of the agents. By using the backup agent to locally manage the agents, the management device does not need to include functionality to communicate with the individual agents; rather, the management device may only be configured to directly communicate with the backup agent. This results in lower overhead related to maintaining the management device, as it does not need to be updated as new agents are used on the production hosts. Further, there is a lower communication overhead as the management device does not need to communicate with the individual agents.

Continuing with the discussion of FIG. 1, in one embodiment of the invention, the classifier (117) includes functionality to obtain, e.g., using plugins or from the backup agent, granular information about the specific types of data that each of the applications is generating and/or managing. Based on this information, the classifier may determine which backup policies of a finite set of backup policies implemented on the production host may be used to protect each type of data identified by the classifier. Additional detail about the operation of the classifier is described with respect to FIGS. 2 and 4 below.

In one embodiment of the invention, the local registry (119) may be a data-structure(s) that specifies, which application specific agents (also referred to as agents (e.g., 114C, 114D)) are executing on each of the production host. Further, the local registry may specify which unique components and common components are currently installed on the production host as well as with which agent(s) each of the unique components and common components is associated. For example, each unique component may only be associated with a single agent while the common components may be associated with multiple agents. The local registry may also specific which applications are installed on the production host. The local registry may include additional and/or different information without departing from the invention.

In one or more of embodiments of the invention, the application specific agents, the backup agents, and the classifier are each implemented as computer instructions, e.g., computer code, stored on a persistent storage that when executed by a processor of the production host (110, 118) cause the production host (110, 118) to perform the aforementioned functionality as well as any other functionality that is described throughout this application.

In one or more embodiments of the invention, the backup storage device(s) (130) manages the backups of virtual machines hosted by the production hosts (110, 118). In one or more embodiments of the invention, the backup storage device(s) (130) stores backups (132) in persistent storage of the backup device or in persistent storage operatively connected to the backup device. The backups (132) may be virtual machine backups. In one or more embodiments of the invention, the virtual machine backups include backups of one or more virtual machines (112A, 112B). A backup may be a data structure that may be used to recover a virtual machine (or a specific application, or data associated with a specific application executing in the virtual machine) to a previous point in time. The backup may include data of the virtual machine, encrypted data of the virtual machine, metadata that references the data of the virtual machine, and/or other data associated with the virtual machine without departing from the invention. The backup storage device(s) may receive backups directly from the agent which generated the backup and/or from the backup agent (116). In the latter scenario, the agents do not interact directly with the backup storage device(s); rather, the backup agent is logically interposed between the agents and the backup storage device (e.g., in a manner similar to the backup agent being logically interposed between the agents and the management device).

In one or more embodiments of the invention, the backup storage device(s) (130) is implemented as physical devices. The physical devices may include circuitry. The physical devices may be, for example, a field-programmable gate array, application specific integrated circuit, programmable processor, microcontroller, digital signal processor, or other hardware processor. The physical devices may be adapted to provide the functionality described throughout this application.

FIGS. 2-4 show flowcharts in accordance with one or more embodiments of the invention. While the various steps in the flowcharts are presented and described sequentially, one of ordinary skill in the relevant art will appreciate that some or all of the steps may be executed in different orders, may be combined or omitted, and some or all steps may be executed in parallel. In one embodiment of the invention, the steps shown in FIGS. 2-4 may be performed in parallel with any other steps shown in FIGS. 2-4 without departing from the scope of the invention.

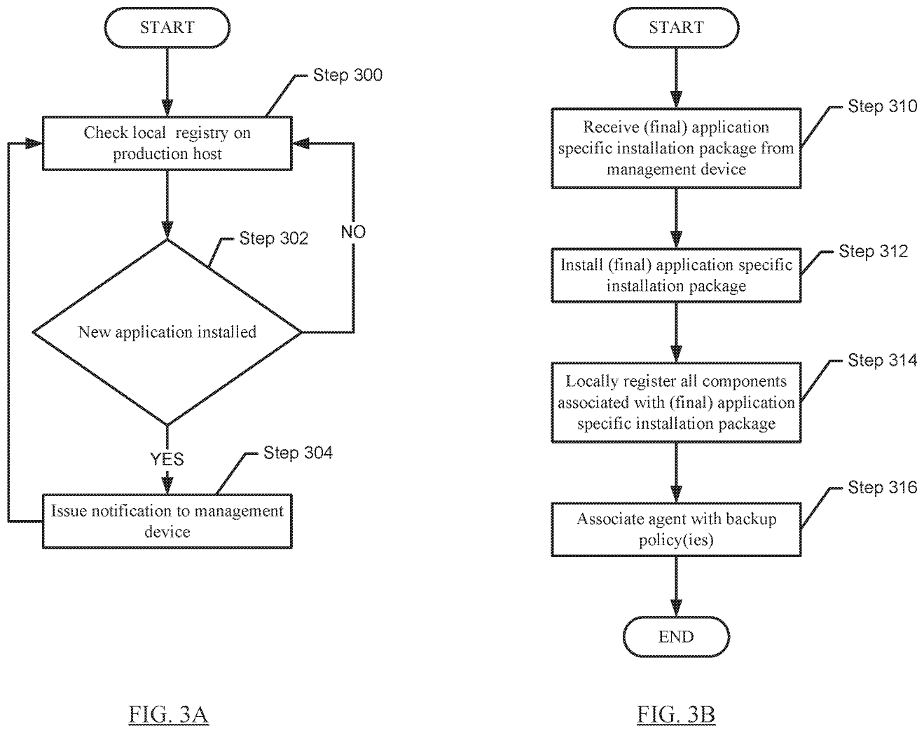

FIG. 2 shows a method for managing backup operations in accordance with one or more embodiments of the invention. The method shown in FIG. 2 may be performed by the management device. Other components in the system may perform the method shown in FIG. 2 without departing from the invention. The method shown in FIG. 2 may be initiated in response to a backup agent performing the method shown in FIG. 3A. Further, the backup agent may initiate the method shown in FIG. 3B after steps 208 or 210 in FIG. 2 is performed.

Turning to FIG. 2, in step 200, a notification is received from the backup agent that a new application has been installed on a production host (i.e., the production host on which the backup agent is executing).

In step 202, an application specific installation package (ASIP) for the application is identified. The ASIP may be identified using the agent repository, where the agent repository includes a mapping between applications and ASIP. The aforementioned mapping may be maintained elsewhere in the management device without departing from the invention. The ASIP may include one or more unique components and zero, one, or more common components that together correspond to the agent for the new application.

At this stage, there may be two scenarios for proceeding. In a first scenario (steps 204-208), the management device may include functionality to determine whether the common components that are part of the ASIP are already installed on the production host and remove such common components. By removing the common components by the management device, less network bandwidth is required to transmit the ASIP (now referred to as the final ASIP (FASIP)). In a second scenario (step 210), the ASIP is transmitted to the production host and the production host (see e.g., FIG. 3B) determines which common components (if any to install).

Continuing with discussion of scenario one, in step 204, a determination is made by the management device about whether the ASIP includes any common components that have already been installed on the production host. The management device may query the global registry to determine which agents have been installed on the production host. The response to this query in combination with information from the agent repository about which common components are associated with each agent may be used to determine whether a given common component has already been installed on the production host. If there any common components that are part of the ASIP have previously been installed on the production host, then the process proceeds to step 206; otherwise, the process proceeds to step 210. The process may also proceed from 206 to step 210 in scenarios in which there are no common components in the ASIP.

In step 206, all previously installed common components are removed from the ASIP to generate a FASIP. While the FASIP may not include any common components, it may include a list (or another data structure) that specifies which common components are part of the agent. This information may be used as part of the registration in step 212 and/or by the backup agent in FIG. 3B.

In step 208, the management device initiates installation of an agent on the host using the FASIP. The initiation of the installation may include transmitting the FASIP to the backup agent on the production host. The process then proceeds to step 212.

As discussed above, if the ASIP does not include any previously installed common components or the determination of whether the ASIP includes any previously installed common components is performed by the backup agent, then in step 210, the management device initiates installation of an agent on the host using the ASIP. The initiation of the installation may include transmitting the ASIP to the backup agent on the production host. The process then proceeds to step 212.

In step 212, the management device registers the agent (i.e., application specific agent installed on the production host using the FASIP or ASIP) with the global registry. The registration may include specifying the production host upon which the agent was installed. Step 212 may be performed by the management device in response to receiving confirmation from the production host that the agent was successfully installed on the production host.

FIG. 3A shows a method for detecting installation of a new application on a production host in accordance with one or more embodiments of the invention. The method shown in FIG. 3A may be performed by the backup agent. Other components may also perform the method shown in FIG. 3A without departing from the invention.

In step 300, the backup agent on the production host queries the local registry. The purpose of the querying is to determine whether there are any new entries in the local registries since the last time the local registry was queried. The local registry may be queried periodically. The frequency at which the local registry is queried may vary based on the implementation of the backup agent.

In step 302, a determination is made, based on the response to the query, whether a new application has been installed on the production host. If a new application has been installed on the production host, then the process proceeds to step 304; otherwise, the process proceeds to step 300.

In step 304, the backup agent issues a notification to the management device, which specifies information about the new application that has been installed on the production host. The information included in the notification is used to perform the method shown in FIG. 2. The process may then end or proceed to step 304.

FIG. 3B shows a method for installing an application specific installation package on a production host in accordance with one or more embodiments of the invention. The method shown in FIG. 3B may be performed by the backup agent. Other components may also perform the method shown in FIG. 3B without departing from the invention.

In step 310, a FASIP (see step 208) or an ASIP (see step 210) is received from the management device.

In step 312, upon receipt of the FASIP or the ASIP, the backup agent begins installation of the agent on the production host using the FSAIP or the ASIP. If the backup agent receives a FASIP, then the backup agent installs all the unique components and any common components included in the FASIP. If the backup agent receives an ASIP, then backup agent installs all the unique components and determines, using the local registry, whether any of the common components included in the ASIP are already installed on the production host. For any common components that are not installed in the production host are installed on the production host.

In step 314, regardless of which unique and/or common components are installed on the host in step 312, all components (unique and common) are registered with the local registry. The registration of the components includes specify a path (i.e., a location) on the production host where the component is installed. The registration enables the unique components to utilize the common components (which may or may not have been previously installed) and also ensures that the local registry is up-to-date. By keeping the local registry up-to-date, duplicate instances of the common components will not be installed on the production hosts.

In step 316, the agent is associated with one or more backup policies. As discussed above, the agent is installed in order to generate backups for a specific application(s). As such, the agent is associated with one or more backup policies, which specify the type of backup to generate (e.g., full, incremental, etc.) as well as when to generate the backup. The backup agent may associate the agent with a default backup policy, a backup policy based on characteristics of the application, and/or any other type of backup policy. The specific backup policy(ies) associated with the agent may be determined by the backup agent.

In one embodiment of the invention, the backup policy(ies) associated with the agent is for the application as a whole—i.e., to backup all application data associated with the application. However, there may be scenarios in which the backup policy may be targeted to a subset of the application data. A method for determining an appropriate backup policy(ies) for a subset of application data is described below in FIG. 4.

In one or more embodiments of the invention, the backup agent may only be able to support a finite number of backup policies. However, there may be scenarios in which there is a large number of different types of application data that need to be backed up, where the number of different types of application data exceeds the number of backup policies that can be supported by the backup agent. In this scenario, there may be a finite set of backup policies where each of the backup policies is associated with a backup group. Said another way, because the backup agent and/or management device can only support a finite number of backup policies at any given time, in scenarios in which there is a large number of assets (i.e., data to protect) it may not possible to generate a unique backup policy for each of the assets. In such scenarios, embodiments of the invention may perform a more granular analyze on the assets and determine whether different assets (e.g., assets of different file types, assets associated with different applications, etc., assets of different sizes, etc.) may be grouped into backup groups, where the backup group may be associated with a single backup policy (or a finite set of backup policies).

FIG. 4 shows a method for associating a backup policy with a heterogeneous set of assets (e.g., different types of application data (or subsets thereof)) on a production host in accordance with one or more embodiments of the invention. While FIG. 4 was described above within the context of the method described in FIG. 2, the method described in FIG. 4 may be used on production hosts that are not implementing the methods described in FIGS. 2-3B.

Turning to FIG. 4, in step 400, backup targets may be obtained by the backup agent and provided to the classifier. The backup targets may correspond to assets that, e.g., a user wants to backup. For example, the target may be a subset of critical files in a file system, where the file system includes a critical data files as well as non-critical system files. In another example, the backup targets may specific data type, application type, or any other metadata or other criterion that may be used to identify specific assets or a specific set of assets in step 404.

In step 402, the backup agent performs asset discovery on the application data on the production host to obtain an asset list. The asset list specifies the application data including data type as well as any other metadata that may be used to filter the asset list. The backup agent may include functionality to either query the applications (e.g., using application specific plugins installed thereon) to obtain information about the corresponding application data and/or to directly analyze the application data in order to generate the asset list.

In step 404, the asset list obtained in step 402 is filtered by the backup agent based on the backup targets to obtain the target asset list. The target asset list includes a list of assets that satisfy at least one criterion specified in the backup targets. The specific contents of the target asset list may vary based on the implementation of the invention. For example, the target asset list may specific a specific set of files, a specific set of folders, a specific type of data (e.g., PDF documents), etc.

In step 406, the assets in the target asset list are classified and subsequently categorized into backup groups by a classifier. The classification in step 406 includes grouping the assets with similar properties into backup groups. For example, the classification may take into account file format, application type (i.e., the application that generated the asset), the size of the assets, the file permissions of the assets, operating system type, asset ownership, access control lists associated with the assets, average access time associated with the assets, average modification times associated with the assets, network location (e.g., subnet, hosts, etc. of the assets, etc. Based on the aforementioned characteristics, the classifier groups assets with similar characteristics into backup groups. The result of the classification may be that heterogeneous assets, e.g., assets of different file types and/or generated by different applications, may be groups into the same backup group.

In step 408, a backup policy is associated with each of the backup groups. The backup policy may be selected from a set of previously generated backup policies. Alternatively, one or more backup policies may be generated by the backup agent based on the specific characteristics of the assets in the backup group. As discussed above, each of the assets is associated with an application. Accordingly, once a backup policy is associated with the backup group, the backup agent determines each application associated with the assets in the backup group and then associates the backup policy with the appropriate agent. When the backup policy is associated with the agent, the backup agent may also specify the specific application data (i.e., the specific assets) that are to be protected using the backup policy.

In step 410, data protection for the assets specified in the backup groups is initiated using the agents installed on the production host. The agents, in accordance with the appropriate backup policies, generate backups for the assets in the backup groups.

### Example

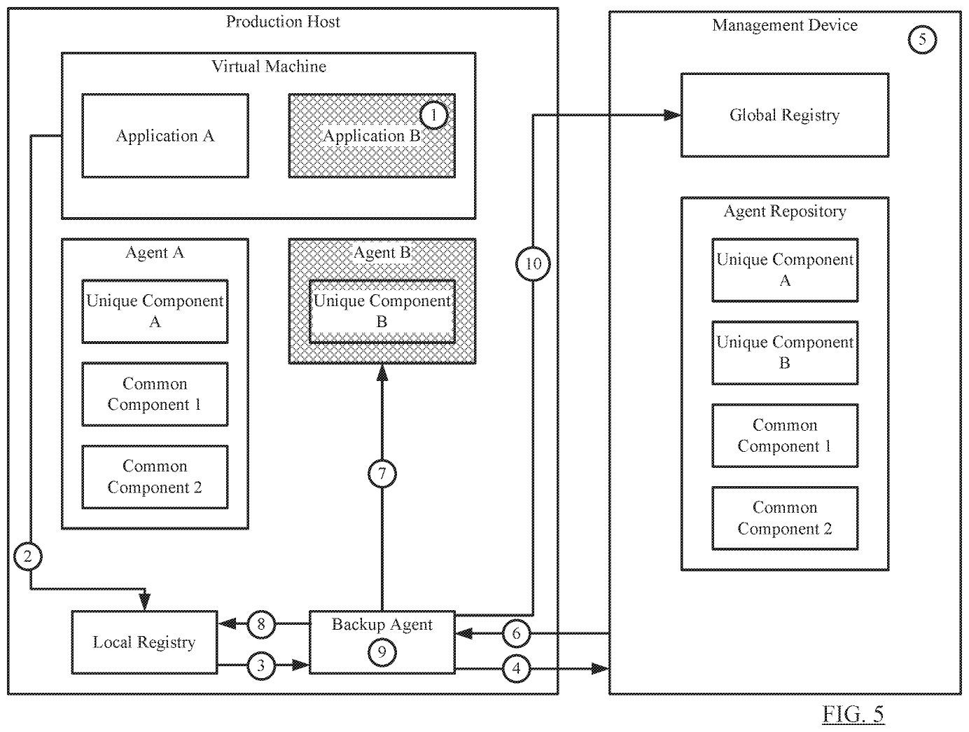

The following section describes an example. The example, illustrated in FIG. 5, is not intended to limit the invention. Each numbered circle illustrated in FIG. 5 may represent a portion of the methods performed by one or more components of the system. The methods may be discussed below.

Turning to the example, consider scenario in which the production host includes a virtual machine, where Application A is installed on the virtual machine. Further, the Agent A is installed on the production host and is configured to generate backups for the application data associated with Application A. In this example, Agent A includes unique component A and common components 1 and 2. All of these components are registered in the local registry.

At some point in time after Application A and Agent A are installed on the production host, Application B is installed on the production host [1]. The installation of Application B results in the local registry being updated to indicate that Application B has been installed [2]. The backup agent (in accordance with FIG. 3A) detects that Application B has been installed on the production host [3] and issues a notification to the management device, where the notification specifies that Application B has been installed on the production host [4].

The management device processes the notification and generates an application specific installation package (ASIP). The management device may use the global registry to determine which agent to install on the production host and then obtain the appropriate components from agent repository to generate the ASIP. In this example, the ASIP includes unique component B, common component 1 and common component 2 [5].

The ASIP is transmitted to the backup agent [6]. The backup agent begins installation of Agent B using the ASIP [7]. The installation includes installing unique component B but not install common components 1 and 2 as they have already been installed on the production host. The determination not to install component components 1 and 2 may be made using the local registry. While Agent B does include its own instance of the common components, the unique component may be configured with information about the location (e.g., path) of the common components installed on the production host. Further, the backup agent may register unique component B in the local registry and add additional registry entries in the local registry to associate unique component B with common components 1 and 2 [8].

After the installation of Agent B is completed, the backup agent automatically assigns one or more backup policies to Agent B, where the backup policies specify when Agent B should generate a backup (e.g., a full or incremental backup of application data from Application B) [9]. Finally, the backup agent may send information to the management device, where the information is used to generate one or more registry entries in the global registry. The registry entries indicate that Agent B is installed on the production host and may also include which backup policies are associated with Agent B [10].

At this stage, the application data for Application A and Application B is protected by Agent A and Agent B, respectively. Further, the operation of the aforementioned agents is locally managed by the backup agents to ensure data protection of application data for Application A and Application B.

### End of Example

As discussed above, embodiments of the invention may be implemented using computing devices. FIG. 6 shows a diagram of a computing device in accordance with one or more embodiments of the invention. The computing device (600) may include one or more computer processors (602), non-persistent storage (604) (e.g., volatile memory, such as random access memory (RAM), cache memory), persistent storage (606) (e.g., a hard disk, an optical drive such as a compact disk (CD) drive or digital versatile disk (DVD) drive, a flash memory, etc.), a communication interface (612) (e.g., Bluetooth interface, infrared interface, network interface, optical interface, etc.), input devices (610), output devices (608), and numerous other elements (not shown) and functionalities. Each of these components is described below.

In one embodiment of the invention, the computer processor(s) (602) may be an integrated circuit for processing instructions. For example, the computer processor(s) may be one or more cores or micro-cores of a processor. The computing device (600) may also include one or more input devices (610), such as a touchscreen, keyboard, mouse, microphone, touchpad, electronic pen, or any other type of input device. Further, the communication interface (612) may include an integrated circuit for connecting the computing device (600) to a network (not shown) (e.g., a local area network (LAN), a wide area network (WAN) such as the Internet, mobile network, or any other type of network) and/or to another device, such as another computing device.

In one embodiment of the invention, the computing device (600) may include one or more output devices (608), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (602), non-persistent storage (604), and persistent storage (606). Many different types of computing devices exist, and the aforementioned input and output device(s) may take other forms.

One or more embodiments of the invention may be implemented using instructions executed by one or more processors of the data management device. Further, such instructions may correspond to computer readable instructions that are stored on one or more non-transitory computer readable mediums.

One or more embodiments of the invention may improve the operation of one or more computing devices. More specifically, embodiments of the invention may improve the data protection of the data stored in the production host by ensuring that the appropriate application agents are installed on the production hosts and configured with the appropriate backup policies. Further, embodiments of the invention enable backup protection of a heterogeneous set of assets using a limited number of backup policies, which reduces the overhead required to protect the heterogeneous set of assets.

Thus, embodiments of the invention may address the complexities related to implementing data protection across a large set of production hosts where the hosts may have different types of applications and data. The problem discussed above should be understood as being an example of problems solved by embodiments of the invention disclosed herein and the invention should not be limited to solving the same/similar problems. The disclosed invention is broadly applicable to address a range of problems beyond those discussed herein.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for managing backups, the method comprising:
in response detecting that a new application has been installed on a production host, issuing a notification to a management device;
receiving, in response to the notification, an application specific installation package;
installing the application specific installation package on the production host to obtain an installed agent on the production host;
associating a backup policy with the agent; and
wherein at least a portion of data associated with the application is backed up in accordance with the backup policy using the agent.

2. The method of claim 1, further comprising:
initiating the registration of the agent in a global registry on the management device.

3. The method of claim 2, wherein initiating the registration of the agent comprises using a backup agent, wherein the backup agent is executing on the production host and is interposed between the agent and the management device.

4. The method of claim 1,
wherein the agent comprises a unique component and a common component;
wherein the application specific installation package comprises the unique component and the common component;
wherein an instance of the common component was installed on the production host prior to the new application being installed;
wherein installing the application specific installation package comprises:
installing the unique component and not installing the common component; and
associating the unique component with the instance of the common component.

5. The method of claim 1,
wherein the agent comprises a unique component and a common component;
wherein the application specific installation package comprises the unique component and not the common component;
wherein an instance of the common component was installed on the production host prior to the new application being installed;
wherein installing the application specific installation package comprises:
installing the unique component and not installing the common component; and
associating the unique component with the instance of the common component.

6. The method of claim 1, wherein associating the backup policy with the agent comprises:
selecting the backup policy from a plurality of backup policies.

7. The method of claim 1, wherein associating the backup policy with the agent comprises:
classifying assets associated with the application, wherein the assets comprise a first set of files of a first type and a second set of file associated with a second type;
determining that only the first set of files is to be backed up using the agent;
selecting the backup policy from a plurality of backup policies, wherein the backup policy is only applied to the first set of files.

8. The method of claim 7, further comprising:
associating the backup policy with a second agent on the production host,
wherein the second agent is associated with a second application executing on the production host,
wherein the second application comprises a third set of files of the first type and a fourth set of files of a third type,
wherein the backup policy is not applied to the fourth set of files.

9. A non-transitory computer readable medium comprising computer readable program code, which when executed by a computer processor enables the computer processor to perform a method for managing backups, the method comprising:
in response detecting that a new application has been installed on a production host, issuing a notification to a management device;
receiving, in response to the notification, an application specific installation package;
installing the application specific installation package on the production host to obtain an installed agent on the production host;
associating a backup policy with the agent; and
wherein at least a portion of data associated with the application is backed up in accordance with the backup policy using the agent.

10. The non-transitory computer readable medium of claim 9, wherein the method further comprises:
initiating the registration of the agent in a global registry on the management device.

11. The non-transitory computer readable medium of claim 10, wherein initiating the registration of the agent comprises using a backup agent, wherein the backup agent is executing on the production host and is interposed between the agent and the management device.

12. The non-transitory computer readable medium of claim 9,
wherein the agent comprises a unique component and a common component;
wherein the application specific installation package comprises the unique component and the common component;
wherein an instance of the common component was installed on the production host prior to the new application being installed;
wherein installing the application specific installation package comprises:
installing the unique component and not installing the common component; and
associating the unique component with the instance of the common component.

13. The non-transitory computer readable medium of claim 9,
wherein the agent comprises a unique component and a common component;
wherein the application specific installation package comprises the unique component and not the common component;
wherein an instance of the common component was installed on the production host prior to the new application being installed;
wherein installing the application specific installation package comprises:
installing the unique component and not installing the common component; and
associating the unique component with the instance of the common component.

14. The non-transitory computer readable medium of claim 9, wherein associating the backup policy with the agent comprises:
selecting the backup policy from a plurality of backup policies.

15. The non-transitory computer readable medium of claim 9, wherein associating the backup policy with the agent comprises:
classifying assets associated with the application, wherein the assets comprise a first set of files of a first type and a second set of file associated with a second type;
determining that only the first set of files is to be backed up using the agent;
selecting the backup policy from a plurality of backup policies, wherein the backup policy is only applied to the first set of files.

16. The non-transitory computer readable medium of claim 15, wherein the method further comprises:
associating the backup policy with a second agent on the production host,
wherein the second agent is associated with a second application executing on the production host,
wherein the second application comprises a third set of files of the first type and a fourth set of files of a third type,
wherein the backup policy is not applied to the fourth set of files.

17. A system, comprising:
a processor;
memory comprising instructions, which when executed by the processor, perform a method, the method comprising:
in response detecting that a new application has been installed on a production host, issuing a notification to a management device;
receiving, in response to the notification, an application specific installation package;
installing the application specific installation package on the production host to obtain an installed agent on the production host;
associating a backup policy with the agent; and
wherein at least a portion of data associated with the application is backed up in accordance with the backup policy using the agent.

18. The system of claim 17, wherein the method further comprises:
initiating the registration of the agent in a global registry on the management device.

19. The system of claim 18, wherein initiating the registration of the agent comprises using a backup agent, wherein the backup agent is executing on the production host and is interposed between the agent and the management device.

20. The system of claim 17,
wherein the agent comprises a unique component and a common component;
wherein the application specific installation package comprises the unique component and the common component;
wherein an instance of the common component was installed on the production host prior to the new application being installed;
wherein installing the application specific installation package comprises:
installing the unique component and not installing the common component; and
associating the unique component with the instance of the common component.
